(19) United States
(12) Patent Application Publication
(10) Pub. No.: US 2024/0249495 A1
(43) Pub. Date: Jul. 25, 2024

(54) INFORMATION PROCESSING DEVICE, INFORMATION PROCESSING METHOD, AND PROGRAM

(71) Applicant: Sony Group Corporation, Tokyo (JP)

(72) Inventor: Kie HORIUCHI, Tokyo (JP)

(73) Assignee: Sony Group Corporation, Tokyo (JP)

(21) Appl. No.: 18/561,739

(22) PCT Filed: Feb. 8, 2022
(86) PCT No.: PCT/JP2022/004810

§ 371 Date: Nov. 17, 2023

(30) Foreign Application Priority Data
May 28, 2021 (JP) 2021-089859

(51) Int. Cl. G06V 10/25; G06T 7/20; G06T 7/50; G06V 10/44; G06V 10/56; G06V 10/74

(52) U.S. Cl. CPC G06V 10/25; G06T 7/20; G06T 7/50; G06V 10/44; G06V 10/56; G06V 10/761; G06T 2207/30196; G06T 2207/30241; G06V 2201/07

(57) ABSTRACT

The present technology relates to an information processing device, an information processing method, and a program enabling follow-up by autonomous movement while appropriately capturing a follow-up target.

It is driven for following a follow-up target, it recognizes the follow-up target, and a recognition algorithm for recognizing the follow-up target is changed on the basis of a distance to the follow-up target or recognition accuracy of the follow-up target based on the distance to the follow-up target, and the drive is controlled on the basis of a position of the recognized follow-up target.

### TECHNICAL FIELD

The present technology relates to an information processing device, an information processing method, and a program, and especially relates to an information processing device, an information processing method, and a program capable of following by autonomous movement while appropriately capturing a follow-up target.

### BACKGROUND ART

Patent Documents 1 and 2 disclose an autonomous mobile robot that follows a follow-up target (mobile target) such as a moving person or object by autonomous movement.

### CITATION LIST

### Patent Document

Patent Document 1: Japanese Patent Application Laid-Open No. 2010-15194
Patent Document 2: Japanese Patent Application Laid-Open No. 2018-147337

### SUMMARY OF THE INVENTION

### Problems to be Solved by the Invention

If an obstacle is interposed between a follow-up target and an autonomous mobile robot in a case where the follow-up target turns a corner or the like, the follow-up target cannot be captured and the autonomous mobile robot cannot appropriately follow the following target in some cases.

The present technology has been made in view of such a situation, and enables follow-up by autonomous movement while appropriately capturing the follow-up target.

### Solutions to Problems

An information processing device or a program according to the present technology is an information processing device including a drive unit that is driven for following a follow-up target, a recognition unit that recognizes the follow-up target, the recognition unit that changes a recognition algorithm for recognizing the follow-up target on the basis of a distance to the follow-up target or recognition accuracy of the follow-up target based on the distance to the follow-up target, and a control unit that controls the drive unit on the basis of a position of the follow-up target recognized by the recognition unit, or a program that allows a computer to serve as such information processing device.

An information processing method according to the present technology is an information processing method of an information processing device including a drive unit, a recognition unit, and a control unit, the method including a drive step for the drive unit to be driven for following a follow-up target, a recognition step for the recognition unit to recognize the follow-up target, the recognition step of changing a recognition algorithm for recognizing the follow-up target on the basis of a distance to the follow-up target or recognition accuracy of the follow-up target based on the distance to the follow-up target, and a control step for the control unit to control the drive at the drive step on the basis of a position of the follow-up target recognized at the recognition step.

In the information processing device, the information processing method, and the program according to the present technology, it is driven for following a follow-up target, it recognizes the follow-up target, and a recognition algorithm for recognizing the follow-up target is changed on the basis of a distance to the follow-up target or recognition accuracy of the follow-up target based on the distance to the follow-up target, and the drive is controlled on the basis of a position of the recognized follow-up target.

### BRIEF DESCRIPTION OF DRAWINGS

FIG. 1 is a block diagram illustrating a configuration example of an embodiment of an autonomous mobile robot to which the present technology is applied.

FIG. 2 is a diagram illustrating a situation in which the autonomous mobile robot cannot capture a follow-up target.

FIG. 3 is a diagram illustrating a state in B of FIG. 2 in a case where an obstacle is a narrow object such as a wall.

FIG. 4 is a diagram illustrating another situation in which the autonomous mobile robot cannot capture the follow-up target.

FIG. 5 is a diagram illustrating another situation in which the autonomous mobile robot cannot capture the follow-up target.

FIG. 6 is a diagram illustrating control for avoiding a state in which the autonomous mobile robot cannot capture the follow-up target due to the obstacle.

FIG. 7 is a diagram illustrating control for avoiding a state in which the autonomous mobile robot cannot capture the follow-up target because the follow-up target goes out of a capturing range.

FIG. 8 is a flowchart illustrating an entire flow of follow-up processing executed by the autonomous mobile robot.

FIG. 9 is a flowchart illustrating processing related to determination of a follow-up position and posture of the autonomous mobile robot at step S14 in FIG. 8.

FIG. 10 is a block diagram illustrating a configuration example of hardware of a computer that executes a series of processing by a program.

### MODE FOR CARRYING OUT THE INVENTION

Hereinafter, an embodiment of the present technology will be described with reference to the drawings.

### <Embodiment of Autonomous Mobile Robot>

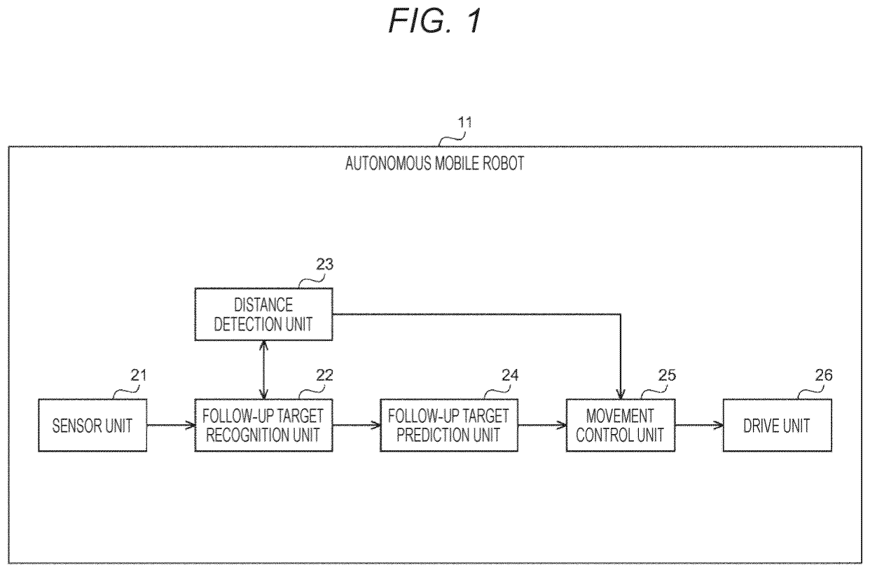

FIG. 1 is a block diagram illustrating a configuration example of an embodiment of an autonomous mobile robot to which the present technology is applied.

An autonomous mobile robot 11 of this embodiment in FIG. 1 autonomously moves, while capturing a moving object (mobile object) such as a person as a follow-up target, so as to follow the follow-up target.

The autonomous mobile robot 11 includes a sensor unit 21, a follow-up target recognition unit 22, a distance detection unit 23, a follow-up target prediction unit 24, a movement control unit 25, and a drive unit 26.

The sensor unit 21 includes a sensor that detects a position and the like of the follow-up target and a sensor that detects an obstacle and the like in a surrounding environment. The sensor unit 21 supplies sensor data output from various sensors to the follow-up target recognition unit 22.

The follow-up target recognition unit 22 recognizes the follow-up target on the basis of the sensor data from the sensor unit 21, and supplies information such as a position regarding the recognized follow-up target to the distance detection unit 23 and the follow-up target prediction unit 24.

The follow-up target recognition unit 22 switches, on the basis of a distance from the autonomous mobile robot 11 to the follow-up target supplied from the distance detection unit 23 and the like, a recognition algorithm for recognizing the follow-up target to an appropriate recognition algorithm depending on the distance.

The distance detection unit 23 calculates the distance from the autonomous mobile robot 11 to the follow-up target (also referred to as a distance of the follow-up target or a follow-up distance) on the basis of the information regarding the follow-up target from the follow-up target recognition unit 22 and the like. The distance detection unit 23 supplies the calculated distance of the follow-up target to the follow-up target recognition unit 22.

The follow-up target prediction unit 24 predicts a future trajectory of the follow-up target on the basis of the information regarding the follow-up target from the follow-up target recognition unit 22. The follow-up target prediction unit 24 supplies the predicted trajectory of the follow-up target (predicted trajectory) to the movement control unit 25.

On the basis of the predicted trajectory from the follow-up target prediction unit 24, the movement control unit 25 determines a position (follow-up position) and a posture to which the autonomous mobile robot 11 is moved every time a new predicted trajectory is supplied. After determining the follow-up position and posture, the movement control unit 25 supplies a drive signal (operation signal) for moving the autonomous mobile robot 11 to the follow-up position and posture to the drive unit 26.

The drive unit 26 includes one or a plurality of actuators that actuates a moving mechanism for the autonomous mobile robot 11 to move. For example, a moving direction and a moving speed of the autonomous mobile robot 11 are controlled by controlling a drive speed of each actuator. An operation signal for indicating the drive speed of the actuator is supplied from the movement control unit 25 to the drive unit 26 so that the autonomous mobile robot 11 moves along a trajectory for moving the autonomous mobile robot 11 from current position and posture to target follow-up position and posture.

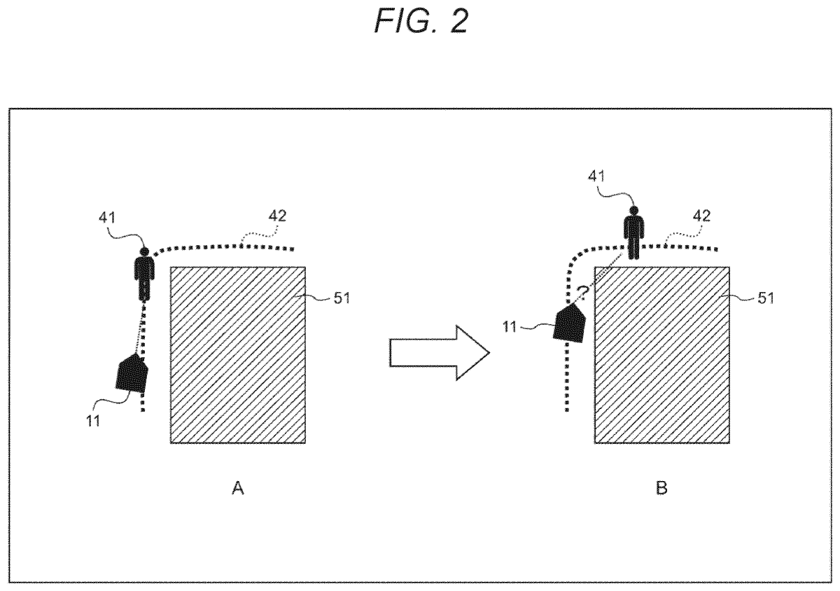

FIG. 2 is a diagram illustrating a situation in which the autonomous mobile robot 11 (autonomous mobile robot to which the present technology is not applied) cannot capture the follow-up target. In A and B of FIG. 2, the autonomous mobile robot 11 is a robot that autonomously moves following the follow-up target. A person 41 is a follow-up target followed by the autonomous mobile robot 11. Note that, a tracking target is not limited to a person. A trajectory 42 is a trajectory (route) through which the person 41 has moved or through which the person is scheduled to move. An obstacle 51 is any object that obstructs passage of the person 41 such as a shelf, a pillar, a wall and the like, for example. In the example in FIG. 2, the obstacle 51 is a rectangular object.

In A of FIG. 2, the person 41 walks on a left side in the drawing of the obstacle 51 along the trajectory 42 toward an upper side in the drawing of the obstacle 51. The autonomous mobile robot 11 follows the person 41 and moves behind the person 41. Note that, hereinafter, an upper side, a lower side, a right side, and a left side in the drawing are simply referred to as an upper side, a lower side, a right side, and a left side.

B of FIG. 2 illustrates a state after a lapse of a predetermined time from A of FIG. 2. In B of FIG. 2, the person 41 turns right at a corner on an upper left end of the obstacle 51 along the trajectory 42, then moves on the upper side of the obstacle 51 toward a right side of the obstacle 51. At that time, while the autonomous mobile robot 11 is moving on the left side of the obstacle 51, a situation occurs in which the obstacle 51 is interposed between the autonomous mobile robot 11 and the person 41, and the autonomous mobile robot 11 cannot capture the person 41.

In this case, it is assumed that the autonomous mobile robot 11 grasps a map around a current position (arrangement of objects), and the number of trajectories 42 through which the person 41 can pass is limited to one. At that time, the autonomous mobile robot 11 predicts that the person 41 is moving on the upper side of the obstacle 51 along the trajectory 42, and the autonomous mobile robot 11 can turn right at the corner on the upper left end of the obstacle 51 along the trajectory 42 to capture the person 41 again.

In contrast, in a case where the number of trajectories 42 is not limited to one, it is difficult for the autonomous mobile robot 11 to capture the person 41 again after the state in B of FIG. 2.

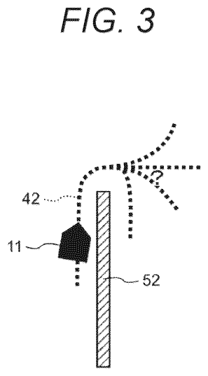

FIG. 3 is a diagram illustrating a state in B of FIG. 2 in a case where the obstacle 52 in FIG. 2 is a narrow object such as a wall. The obstacle 52 is the narrow object arranged in place of the obstacle 52 in FIG. 2. That is, FIG. 3 illustrates a state in which the person 41 turns right at a corner on an upper left end of the obstacle 52 in a manner similar to the movement of the person 41 from A of FIG. 2 to B of FIG. 2.

In this case, the obstacle 52 is interposed between the autonomous mobile robot 11 and the person 41, and the autonomous mobile robot 11 cannot capture the person 41. At that time, the autonomous mobile robot 11 cannot even predict whether the trajectory 42 after the person 41 turns right at a corner on an upper right end of the obstacle 52 is directed rightward, downward or the like. Therefore, it is difficult for the autonomous mobile robot 11 to capture the person 41 again after the person 41 turns right at the corner on the upper left end of the obstacle 51.

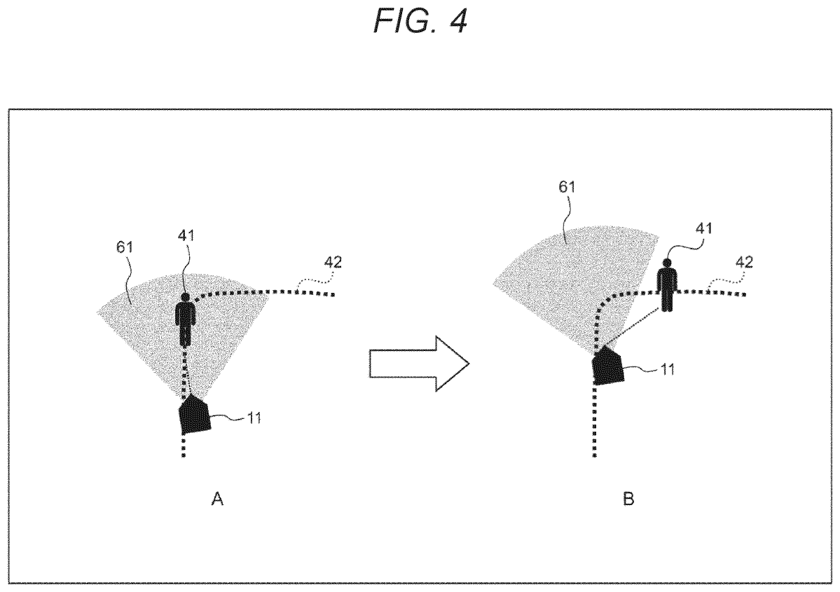

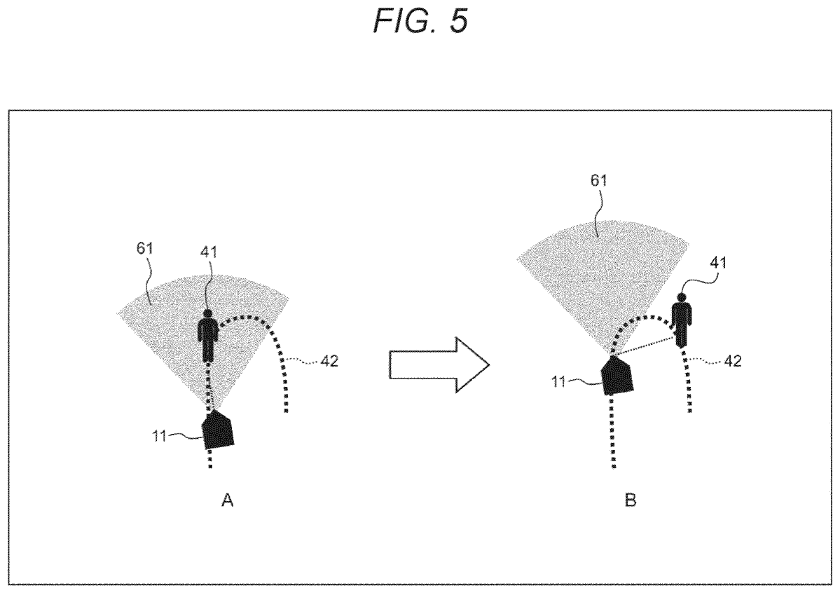

FIGS. 4 and 5 are diagrams illustrating another situation in which the autonomous mobile robot 11 cannot capture the follow-up target. In A and B of FIG. 4 and A and B of FIG. 5, the autonomous mobile robot 11 is a robot that autonomously moves following the follow-up target. A person 41 is a follow-up target followed by the autonomous mobile robot 11. The trajectory 42 is the trajectory through which the person 41 has moved or through which the person is scheduled to move. A capturing range 61 represents a range in which the autonomous mobile robot 11 can capture the follow-up target.

In A of FIG. 4, the person 41 is walking toward an upper side along the trajectory 42. The autonomous mobile robot 11 follows the person 41 while capturing the person 41 within the capturing range 61 and moves behind the person 41.

B of FIG. 4 illustrates a state after a lapse of a predetermined time from A of FIG. 4. In B of FIG. 4, the person 41 turns right along the trajectory 42, and then moves toward a right side. At that time, when the person 41 deviates from the capturing range 61, a situation occurs in which the autonomous mobile robot 11 cannot capture the person 41.

In A of FIG. 5, the person 41 is walking toward the upper side along the trajectory 42 in a manner similar to that in A of FIG. 4. The autonomous mobile robot 11 follows the person 41 while capturing the person 41 within the capturing range 61 and moves behind the person 41.

B of FIG. 5 illustrates a state after a lapse of a predetermined time from A of FIG. 5. In B of FIG. 4, the person 41 rotates right along the trajectory 42, and then moves toward a lower side. At that time, when the person 41 deviates from the capturing range 61, a situation occurs in which the autonomous mobile robot 11 cannot capture the person 41.

In cases in FIGS. 4 and 5, there is a case where the trajectory 42 is not a specific trajectory limited by the obstacle or the like. In this case, it is difficult for the autonomous mobile robot 11 to predict the trajectory 42. Therefore, it is difficult for the autonomous mobile robot 11 to capture the person 41 again after the state in B of FIG. 4 or B of FIG. 5.

### DESCRIPTION OF PRESENT TECHNOLOGY

The present technology controls the autonomous mobile robot 11 so that the states in B of FIG. 2, FIG. 3, B of FIG. 4, and B of FIG. 5 do not occur.

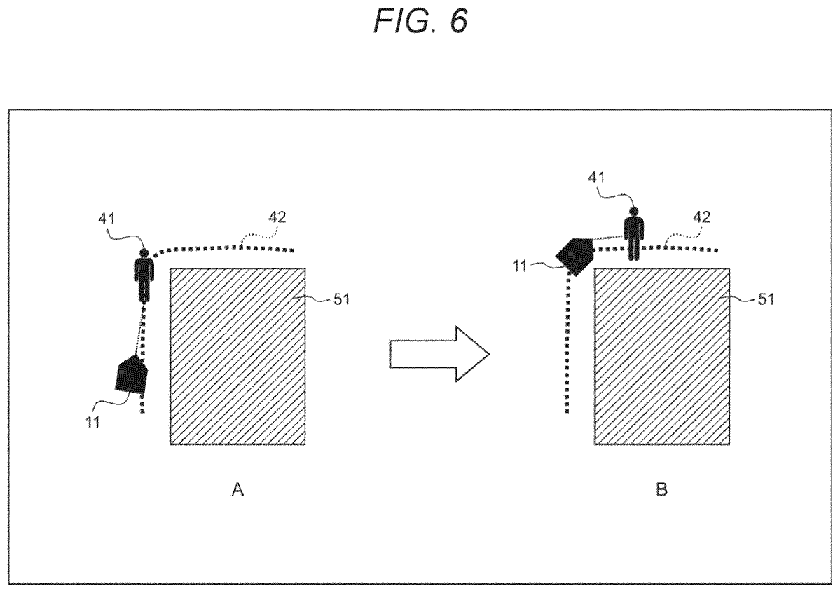

FIG. 6 is a diagram illustrating control of the autonomous mobile robot 11 for avoiding the state in B of FIG. 2, that is, a state in which the autonomous mobile robot 11 cannot capture the follow-up target due to the obstacle. A of FIG. 6 is the same as A of FIG. 2, so that description thereof is omitted.

B of FIG. 6 illustrates a state after a lapse of a predetermined time from A of FIG. 6. In B of FIG. 6, the person 41 turns right at the corner on the upper left end of the obstacle 51 along the trajectory 42, then moves on the upper side of the obstacle 51 toward the right side of the obstacle 51. The autonomous mobile robot 11 predicts in advance the trajectory 42 through which the person 41 is scheduled to move. As a result of the prediction, when the autonomous mobile robot 11 predicts that there is a possibility that the person 41 cannot be captured due to the obstacle 51 as in B of FIG. 2, this approaches the person 41 to a position closer than a position at a normal distance (position at a shorter distance). Therefore, in B of FIG. 6, even after the person 41 turns right at the corner on the upper left end of the obstacle 51, the autonomous mobile robot 11 can continuously capture and follow the person 41 without being obstructed by the obstacle 51.

In the case in FIG. 3, similarly, the autonomous mobile robot 11 can avoid a state in which the person 41 cannot be captured due to the obstacle 52 by approaching the person 41 to a distance shorter than the normal distance.

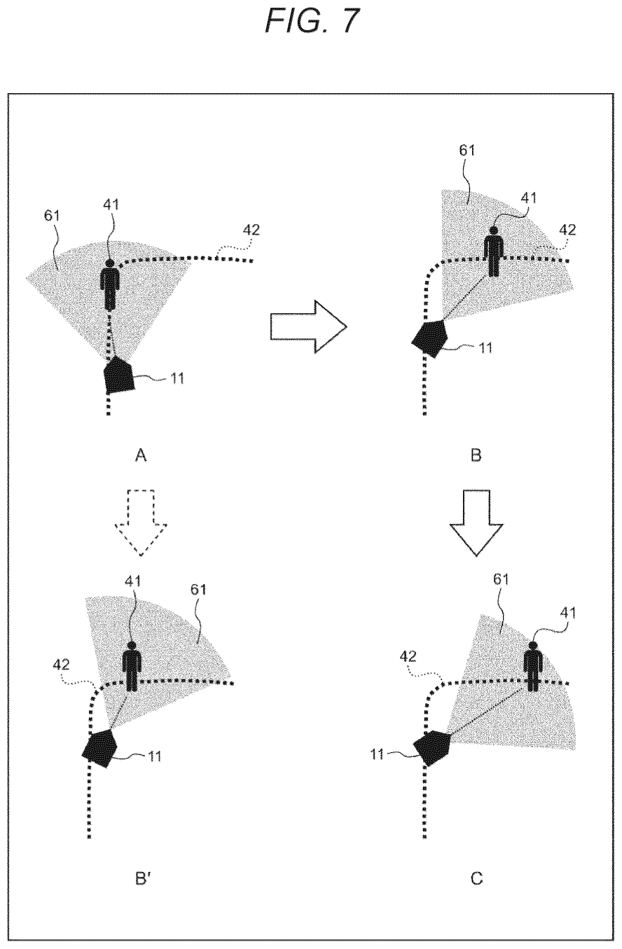

FIG. 7 is a diagram illustrating control of the autonomous mobile robot 11 for avoiding the states in B of FIG. 4 and B of FIG. 5, that is, states in which the autonomous mobile robot 11 cannot capture the follow-up target because the follow-up target goes out of the capturing range. A of FIG. 7 is the same as A of FIG. 4, so that description thereof is omitted.

B of FIG. 7 illustrates a state after a lapse of a predetermined time from A of FIG. 7. In B of FIG. 7, the person 41 turns right along the trajectory 42, and then moves toward the right side. The autonomous mobile robot 11 predicts the trajectory 42 through which the person 41 is scheduled to move. On the basis of the result of the prediction, the autonomous mobile robot 11 moves while changing a direction of the capturing range 61 so that the person 41 does not deviate from the capturing range 61 as in B of FIG. 4 or B of FIG. 5.

C of FIG. 7 illustrates a state after a lapse of a predetermined time from B of FIG. 7. In C of FIG. 7, the person 41 moves toward the right side along the trajectory 42. The autonomous mobile robot 11 moves while changing the direction of the capturing range 61 so that the person 41 does not deviate from the capturing range 61 as in the case in B of FIG. 7.

Here, the autonomous mobile robot 11 needs to move a certain distance in order to change the direction of the capturing range 61 in some cases. In this case, the autonomous mobile robot 11 is controlled to approach the person 41 to a distance shorter than the normal distance to change the direction of the capturing range 61.

B′ of FIG. 7 illustrates a state after a lapse of a predetermined time from A of FIG. 7 in a case where the autonomous mobile robot 11 is controlled to approach the follow-up target to a distance shorter than the normal distance. The person 41 turns right along the trajectory 42, and then moves toward the right side. The autonomous mobile robot 11 predicts the trajectory 42 through which the person 41 is scheduled to move. As a result of the prediction, in a case where there is a possibility that the person 41 deviates from the capturing range 61 with the normal movement of the autonomous mobile robot 11 and the change in direction of the capturing range 61, the autonomous mobile robot 11 moves closer to the person 41 to a distance shorter than the normal distance, thereby changing the capturing range 61 to an appropriate direction.

Note that, in a case where the person 41 moves in the direction deviating from the capturing range 61, the autonomous mobile robot 11 may control to approach the person 41 to a distance shorter than the normal distance as in B′ of FIG. 7.

Even in a case where the person 41 rotates as in FIG. 5, the autonomous mobile robot 11 can move as in the case of FIG. 7, thereby avoiding the deviation of the person 41 from the capturing range 61. The description of the control of the autonomous mobile robot 11 with respect to the movement of the person 41 in FIG. 5 is omitted.

As described above, in a case where the autonomous mobile robot 11 approaches the follow-up target to a distance shorter than the normal distance, there is a case where the capturing range 61 includes only a part of the follow-up target. At that time, if recognition processing (recognition algorithm) for recognizing the follow-up target is the same as that in a normal case, a situation in which the follow-up target cannot be appropriately captured might occur. The present technology enables the autonomous mobile robot 11 to appropriately recognize (capture) the follow-up target in a case of approaching the follow-up target to a distance shorter than the normal distance.

### <Details of Processing in Respective Components of Autonomous Mobile Robot 11>

Processing of the follow-up target recognition unit 22 in FIG. 1 in a case where control is performed to bring the autonomous mobile robot 11 close to the follow-up target to a distance shorter than the normal distance in order to avoid the follow-up target from deviating from the capturing range 61 will be described.

The sensor unit 21 includes a sensor for detecting a direction and a distance of the follow-up target from the autonomous mobile robot 11. The sensor unit 21 includes at least one of one or a plurality of cameras that images a color image (RGB image) or a monochrome image, or a ranging sensor capable of measuring a distance to a multipoint measurement point such as a light detection and ranging (LiDAR) or a ToF camera. The sensor included in the sensor unit 21 differs depending on processing performed by the follow-up target recognition unit 22, and can be appropriately changed depending on a utilization case of the autonomous mobile robot 11. Note that, the sensor of the sensor unit 21 is assumed to be fixed to the autonomous mobile robot 11, but there is not limitation.

The follow-up target recognition unit 22 recognizes the follow-up target on the basis of the sensor data from the sensor unit 21. The processing of recognizing the follow-up target (recognition algorithm) varies depending on a type of the sensor of the sensor unit 21, and is changed depending on the distance of the follow-up target. The recognition algorithm for recognizing the follow-up target is roughly divided into a normal recognition algorithm (recognition algorithm for normal distance) in a case where the follow-up target is at the normal distance from the autonomous mobile robot 11 and a recognition algorithm for short distance in a case where the follow-up target approaches the autonomous mobile robot 11. The recognition algorithm for short distance is used in a case where the autonomous mobile robot 11 (sensor) is too close to the follow-up target and it is difficult to recognize the follow-up target with the normal recognition algorithm.

### (Normal Recognition Algorithm)

As the normal recognition algorithm, for example, there are following first to fourth recognition algorithms, and any of them can be adopted.

### (First Recognition Algorithm)

The first recognition algorithm is an algorithm in a case where the sensor unit 21 includes the camera. In the first recognition algorithm, the follow-up target recognition unit 22 acquires an image (camera image) imaged by the camera as the sensor data. The follow-up target recognition unit 22 detects an image (image region) matching features such as an entire shape and color distribution of the follow-up target from within a region of the camera image acquired from the camera. As a result, the follow-up target recognition unit 22 recognizes the follow-up target present in the capturing range 61 with an imaging range of the camera as the capturing range 61.

### (Second Recognition Algorithm)

The second recognition algorithm is an algorithm in a case where the sensor unit 21 includes the camera, and is different from the first recognition algorithm. In the second recognition algorithm, the follow-up target recognition unit 22 acquires an image (camera image) imaged by the camera as the sensor data. The follow-up target recognition unit 22 detects an image region of a moving object (mobile object) from within a region of the camera image on the basis of a change in time of the camera image acquired from the camera at predetermined time intervals. As a result, the follow-up target recognition unit 22 recognizes the follow-up target present in the capturing range 61 with an imaging range of the camera as the capturing range 61.

### (Third Recognition Algorithm)

The third recognition algorithm is an algorithm in a case where the sensor unit 21 includes the ranging sensor. In the third recognition algorithm, the follow-up target recognition unit 22 acquires ranging data being a result of ranging by the ranging sensor as the sensor data. The ranging data is a set of data of distances to objects (measurement points) measured in a large number (a plurality) of different orientations (directions) from the ranging sensor. The follow-up target recognition unit 22 detects a region of a moving object (mobile object) from within a ranging range of the ranging sensor on the basis of a change in time of the ranging data acquired from the ranging sensor at predetermined time intervals. As a result, the follow-up target recognition unit 22 recognizes the follow-up target present in the capturing range 61 with the ranging range of the ranging sensor as the capturing range 61.

### (Fourth Recognition Algorithm)

The fourth recognition algorithm is an algorithm in a case where the sensor unit 21 includes the ranging sensor, and is different from the third recognition algorithm. In the fourth recognition algorithm, the follow-up target recognition unit 22 acquires ranging data being a result of ranging by the ranging sensor as the sensor data. The follow-up target recognition unit 22 detects a region matching a shape of the follow-up target from within a measurement range of the ranging data acquired from the ranging sensor. As a result, the follow-up target recognition unit 22 recognizes the follow-up target present in the capturing range 61 with the ranging range of the ranging sensor as the capturing range 61.

### (Recognition Algorithm for Short Distance)

As the recognition algorithm for short distance, there are following fifth to eighth recognition algorithms, and any of them can be adopted.

### (Fifth Recognition Algorithm)

The fifth recognition algorithm is an algorithm in a case where the sensor unit 21 includes the camera, and is different from the first and second recognition algorithms being the normal recognition algorithms. In the fifth recognition algorithm, the follow-up target recognition unit 22 acquires an image (camera image) imaged by the camera as the sensor data. The follow-up target recognition unit 22 detects an image region (matching region) matching a representative color of the follow-up target from within a region of the camera image acquired from the camera. In a case where the matching region matching the representative color of the follow-up target is detected at a plurality of sites, as an example, the follow-up target recognition unit 22 compares the plurality of matching regions with an image region (matching region) of the follow-up target recognized from the camera image acquired one frame before from the camera of the sensor unit 21 (the camera image used in the recognition processing of the follow-up target one time before). As a result of the comparison, the follow-up target recognition unit 22 recognizes the matching region having the closest area as the image region to be follow-up target. Note that, the matching region may be detected by an HSV color space so that the color in the camera image is not affected by light. As a result, the follow-up target recognition unit 22 recognizes the follow-up target present in the capturing range 61 with an imaging range of the camera as the capturing range 61.

### (Sixth Recognition Algorithm)

The sixth recognition algorithm is an algorithm in a case where the sensor unit 21 includes the camera, and is different from the first and second recognition algorithms being the normal recognition algorithms, and the fifth recognition algorithm being the recognition algorithm for short distance. In the sixth recognition algorithm, the follow-up target recognition unit 22 acquires an image (camera image) imaged by the camera as the sensor data. The follow-up target recognition unit 22 detects (extracts) an image region (matching region) matching a partial or local feature amount of the image of the follow-up target from within a region of the camera image acquired from the camera. Detection of the image region matching the feature amount of the follow-up target (matching) is performed in consideration of enlargement or reduction of the image of the follow-up target in the camera image. As a matching method, a well-known method of detecting (extracting) a local image feature amount such as scale-invariant feature transform (SIFT), speeded-up robust features (SURF), histograms of oriented gradients (HOG), or Harr-like may be used. The follow-up target recognition unit 22 recognizes the detected matching region as the image region of the follow-up target. As a result, the follow-up target recognition unit 22 recognizes the follow-up target present in the capturing range 61 with an imaging range of the camera as the capturing range 61.

### (Seventh Recognition Algorithm)

The seventh recognition algorithm is an algorithm in a case where the sensor unit 21 includes the camera, and is different from the first and second recognition algorithms being the normal recognition algorithms, and the fifth and sixth recognition algorithms being the recognition algorithms for short distance. In the sixth recognition algorithm, the follow-up target recognition unit 22 acquires an image (camera image) imaged by the camera as the sensor data. The follow-up target recognition unit 22 detects (extracts) an image region of the follow-up target or an image region (matching region) matching a partial or local feature amount of the follow-up target from within a region of the camera image acquired from the camera using an inference model in machine learning. The follow-up target recognition unit 22 recognizes the detected matching region as the image region of the follow-up target. The inference model has a structure of neural network such as convolutional neural network (CNN), for example. Learning of the inference model is performed, for example, by using a plurality of camera images (for five to ten frames) from several frames before the camera image in which the follow-up target recognition unit 22 recognizes the image region of the follow-up target the last as input data, and using the image region of the follow-up target recognized for the camera images as the input data as correct answer data. As a result, the follow-up target recognition unit 22 recognizes the follow-up target present in the capturing range 61 with an imaging range of the camera as the capturing range 61.

### (Eighth Recognition Algorithm)

The eighth recognition algorithm is an algorithm in a case where the sensor unit 21 includes the ranging sensor, and is different from the third and fourth recognition algorithms being the normal recognition algorithms. In the eighth recognition algorithm, the follow-up target recognition unit 22 acquires ranging data being a result of ranging by the ranging sensor as the sensor data. The follow-up target recognition unit 22 detects, from within the measurement range of the ranging data acquired from the ranging sensor, a region of a moving object (mobile object) the closest to the position where the follow-up target is recognized the last, as a region of the follow-up target. As a result, the follow-up target recognition unit 22 recognizes the follow-up target present in the capturing range 61 with the ranging range of the ranging sensor as the capturing range 61. Note that, when detecting the region of the follow-up target, the follow-up target recognition unit 22 may improve recognition accuracy of the follow-up target by adding a size of the follow-up target and coincidence with an average moving speed of the follow-up target as a condition. For example, in a case where the follow-up target is a person, the condition regarding the moving speed (walking speed) is, for example, about 2 m/s or lower.

### (Distance Detection Processing)

The distance detection unit 23 detects the distance of the follow-up target recognized by the follow-up target recognition unit 22 to the autonomous mobile robot 11 (the distance to the follow-up target).

In a case where the sensor unit 21 includes a plurality of cameras such as a stereo camera, the follow-up target recognition unit 22 detects a region (image region) of the follow-up target in the capturing range 61 (camera image of each camera) by any one of the first, second, and fifth to seventh recognition algorithms, and supplies information (follow-up target recognition information) specifying a position and a range of the region of the follow-up target in the capturing range 61 (camera image of each camera) to the distance detection unit 23.

On the basis of the follow-up target recognition information from the follow-up target recognition unit 22, the distance detection unit 23 detects a parallax amount (deviation amount) of the position of the image region of the follow-up target in the camera image of each camera, and detects (calculates) the distance of the follow-up target using the principle of triangulation. The detected distance of the follow-up target is supplied to the follow-up target recognition unit 22.

In a case where the sensor unit 21 includes the ranging sensor, the follow-up target recognition unit 22 detects the region of the follow-up target in the capturing range 61 (ranging range of the ranging sensor) by the third, fourth, or eighth recognition algorithm, and supplies information (follow-up target recognition information) specifying a position and a range of the region of the follow-up target in the ranging range of the ranging sensor to the distance detection unit 23.

On the basis of the follow-up target recognition information from the follow-up target recognition unit 22 and the ranging data from the sensor unit 21 or the follow-up target recognition unit 22, the distance detection unit 23 extracts the distance of each measurement point in the region of the follow-up target in the ranging range of the ranging sensor, and detects (calculates), for example, an average value of the extracted distances of the measurement points as the distance of the follow-up target. The detected distance of the follow-up target is supplied to the follow-up target recognition unit 22.

In a case where the sensor unit 21 includes both the camera and the ranging sensor, the follow-up target recognition unit 22 can recognize the region of the follow-up target in the capturing range 61 using any of the first to eighth recognition algorithm. In this case, the distance detection unit 23 can detect the distance of the follow-up target in a manner similar to that in a case where the sensor unit 21 described above includes a plurality of cameras or a case where the sensor unit 21 includes the ranging sensor.

In a case where the sensor unit 21 includes both the camera and the ranging sensor, and in a case where there is only one camera for recognizing the follow-up target, when the follow-up target recognition unit 22 recognizes the region of the follow-up target by any of the first, second, and fifth to seventh recognition algorithms, the distance detection unit 23 obtains the region of the follow-up target in the ranging range of the ranging sensor on the basis of the follow-up target recognition information from the follow-up target recognition unit 22. On the basis of the obtained region of the follow-up target and the ranging data from the sensor unit 21 or the follow-up target recognition unit 22, the distance detection unit 23 extracts the distance of each measurement point in the region of the follow-up target in the ranging range of the ranging sensor, and detects (calculates), for example, an average value of the extracted distances of the measurement points as the distance of the follow-up target. The detected distance of the follow-up target is supplied to the follow-up target recognition unit 22. Note that, even in a case where the sensor unit 21 includes a plurality of cameras, when the follow-up target recognition unit 22 recognizes the region of the follow-up target by any of the first, second, and fifth to seventh recognition algorithms, the distance detection unit 23 can also detect the distance of the follow-up target in a manner similar to that in a case where there is only one camera.

### (Recognition Algorithm Depending on Distance)

The follow-up target recognition unit 22 switches the recognition algorithm depending on the distance of the follow-up target from the distance detection unit 23. For example, in a case where the distance of the follow-up target is a predetermined threshold (distance threshold) or longer, this is the normal distance suitable for the recognition of the follow-up target by the normal recognition algorithm. The normal distance is, for example, a distance at which the follow-up target recognition unit 22 can recognize an entire follow-up target. In a case where the distance of the follow-up target is shorter than the distance threshold, the follow-up target recognition unit 22 sets the short distance suitable for the recognition of the follow-up target by the algorithm for short distance.

Note that, the follow-up target recognition unit 22 is not limited to a case of directly switching the recognition algorithm of the follow-up target on the basis of the distance of the follow-up target. For example, when the follow-up target is recognized by the normal recognition algorithm, in a case where the recognition of the follow-up target becomes unstable or in a case where it is determined to be unstable (in a case where the recognition accuracy of the follow-up target is deteriorated), the follow-up target recognition unit 22 may regard that the distance of the follow-up target is a short distance (shorter than the distance threshold) and switch from the normal recognition algorithm to the recognition algorithm for short distance to recognize the follow-up target. A case where the recognition of the follow-up target becomes unstable includes a case where likelihood of the recognized follow-up target is smaller than a predetermined threshold, a case where the follow-up target cannot be recognized for a predetermined time or longer and the like. A case where it is determined that the recognition of the follow-up target becomes unstable includes a case where a part of the follow-up target is outside the capturing range 61, a case where the distance of the follow-up target is shortened by a predetermined distance or longer from a state in which the distance is continuously maintained at a stable distance or the like.

### (Trajectory Prediction of Follow-up Target)

The follow-up target prediction unit 24 acquires the follow-up target recognition information that specifies the position and range of the region of the follow-up target in the capturing range 61 from the follow-up target recognition unit 22. The follow-up target recognition information includes the distance of the follow-up target.

The follow-up target prediction unit 24 detects a current position of the follow-up target (current position) on the basis of the follow-up target recognition information and self-position information for specifying the position and posture of the autonomous mobile robot 11. The self-position information is obtained by information of a control amount of the drive unit 26, information from a sensor such as an IMU that measures the self-position, self-position estimation using a technology of simultaneous localization and mapping (SLAM) or the like. A sensor that detects an external situation such as the LiDAR, camera, or ToF sensor used in the SLAM or the like may be a sensor shared by the sensor such as the camera, ranging sensor and the like of the sensor unit 21 that recognizes the follow-up target, or may be a sensor installed in the autonomous mobile robot 11 separately from the sensor that recognizes the follow-up target.

Note that, the follow-up target prediction unit 24 stores the position of the follow-up target detected up to the present time in a storage unit not illustrated as movement history information (time and position information) of the follow-up target.

The follow-up target prediction unit 24 predicts the trajectory (future trajectory) of the follow-up target on the basis of the detected current position of the follow-up target, movement history information and the like. The trajectory is information indicating time at predetermined time intervals and a position (predicted position) at each time.

Any method such as a method using a particle filter or a method using a moving model is used, for example, to predict the trajectory of the follow-up target.

For example, in the method using the particle filter, the follow-up target prediction unit 24 estimates a trajectory through which the current follow-up target is predicted to move in the future on the basis of the movement history information (movement trajectory information) when the follow-up target (not limited to the current follow-up target) has moved in the past in the same section and the movement history information up to the present time of the current follow-up target. The movement history information when the follow-up target has moved in the past is stored in advance in a storage unit not illustrated. When predicting the trajectory of the follow-up target, the follow-up target prediction unit 24 supposes a large number of states (trajectories) and calculates likelihood of each supposed trajectory. The follow-up target prediction unit 24 sets, as the trajectory of the follow-up target, the trajectory having the highest likelihood among the large number of trajectories.

In the method using the moving model, for example, the autonomous mobile robot 11 predicts the trajectory of the follow-up target on the assumption that the follow-up target moves at a current moving speed and along a route having the same curvature radius as the current one.

In another method (social force model) using the moving model, the trajectory of the follow-up target is predicted on the assumption that the follow-up target moves so as to avoid another mobile object.

Note that, the follow-up target prediction unit 24 may store a map of a section where the follow-up target moves in a storage unit not illustrated in advance. In this case, the follow-up target prediction unit 24 may predict the trajectory of the follow-up target only on a passage through which the follow-up target can move on the basis of the stored map.

The follow-up target prediction unit 24 may predict the trajectory of the follow-up target on the condition that the follow-up target moves while avoiding the obstacle in consideration of the presence of the obstacle. The follow-up target prediction unit 24 may detect the position of the obstacle on the basis of the map stored in advance or on the basis of the sensor data obtained by the ranging sensor such as the LiDAR. The ranging sensor in this case may be the sensor shared by the sensor that recognizes the follow-up target, or may be the sensor installed in the autonomous mobile robot 11 separately from the sensor that recognizes the follow-up target.

### (Movement Control of Autonomous Mobile Robot 11)

The movement control unit 25 determines a position (follow-up position) and a posture (orientation) which the autonomous mobile robot 11 should reach at a point in time (predicted time) after a lapse of a predetermined time from the present time on the basis of the trajectory of the follow-up target predicted by the follow-up target prediction unit 24.

When determining the follow-up position and posture, the movement control unit 25 satisfies following first and second conditions in principle (except for a case of exception).

The first condition is that the follow-up position of the autonomous mobile robot 11 is separated from the position of the follow-up target (predicted position) by the normal distance at the predicted time in a case where the follow-up target moves along the trajectory predicted by the follow-up target prediction unit 24. As described above, the normal distance is a distance suitable for the follow-up target recognition unit 22 to recognize the follow-up target by the normal recognition algorithm, and refers to a distance within a range equal to or longer than a predetermined distance threshold. Note that, the normal distance may be a distance equal to or longer than a predetermined distance threshold and equal to or shorter than a predetermined upper limit value. In principle, the movement control unit 25 determines the follow-up position so that a distance between the predicted position of the follow-up target and the follow-up position of the autonomous mobile robot 11 becomes a substantially constant distance within a range of the normal distance.

The second condition is that the capturing range 61 in the follow-up position and posture of the autonomous mobile robot 11 includes (captures) the follow-up target in the predicted position at the predicted time in a case where the follow-up target moves along the trajectory predicted by the follow-up target prediction unit 24.

The movement control unit 25 determines the follow-up position and posture of the autonomous mobile robot 11 after a lapse of a predetermined time so as to satisfy the first and second conditions except for a case of exception. The movement control unit 25 further determines the trajectory of the autonomous mobile robot 11 so that the position and the posture of the autonomous mobile robot 11 after a lapse of a predetermined time become the determined follow-up position and posture.

The movement control unit 25 considers the presence of the obstacle when determining the follow-up position and posture of the autonomous mobile robot 11. The position of the obstacle is information that can also be considered by the follow-up target prediction unit 24, and is detected by the movement control unit 25 similarly to a case of being detected by the follow-up target prediction unit 24.

When determining the follow-up position and posture of the autonomous mobile robot 11 in accordance with the principle, the movement control unit 25 determines the follow-up position and posture of the autonomous mobile robot 11 after a lapse of a predetermined time except for a case where there is a possibility that the obstacle is interposed between the autonomous mobile robot 11 and the follow-up target or a case where there is a possibility that the follow-up target deviates from the capturing range 61. In a case of exception, the movement control unit 25 disables limitation by the first condition and determines the follow-up position and posture of the autonomous mobile robot 11 so as to satisfy the second condition. Note that, the second condition is satisfied also in a case where the capturing range 61 of the autonomous mobile robot 11 includes only a part of the follow-up target.

At that time, the movement control unit 25 may determine the follow-up position and posture of the autonomous mobile robot 11 so that the distance between the predicted position of the follow-up target and the follow-up position of the autonomous mobile robot 11 becomes shorter than the normal distance (the above-described distance threshold), thereby avoiding a situation in which the obstacle is interposed between the autonomous mobile robot 11 and the follow-up target or a situation in which the follow-up target deviates from the capturing range 61. Note that, in a case where these situations can be avoided when the distance between the predicted position of the follow-up target and the follow-up position of the autonomous mobile robot 11 is the normal distance, the movement control unit 25 does not necessarily determine the follow-up position and posture of the autonomous mobile robot 11 so that the distance becomes shorter than the normal distance (distance threshold described above).

As a case of exception, when determining the follow-up position and posture of the autonomous mobile robot 11 after a lapse of a predetermined time, the movement control unit 25 determines the trajectory of the autonomous mobile robot 11 so that the position and posture of the autonomous mobile robot 11 after a lapse of a predetermined time become the determined follow-up position and posture.

Here, when determining the trajectory of the autonomous mobile robot 11 in a case of the principle or in a case of exception, a trajectory plan setting method such as Hybrid A* that prevents collision with an obstacle in consideration of the posture of the autonomous mobile robot 11 may be used. Moreover, for the determined trajectory, a method such as Dynamic WaveArc (DWA) for changing the trajectory in consideration of dynamic obstacles and dynamics of the autonomous mobile robot 11 may be used. A learning method such as reinforcement learning may be used so that the autonomous mobile robot 11 can move toward the follow-up position and posture without colliding with an obstacle.

In a case of the principle, or in a case of exception, when the trajectory of the autonomous mobile robot 11 is determined, a drive signal (operation signal) for moving the autonomous mobile robot 11 is supplied to the drive unit 26 according to the trajectory. As a result, the autonomous mobile robot 11 moves along the trajectory determined by the movement control unit 25.

Note that, in a case where an object or an obstacle of the same type as the follow-up target is interposed between the follow-up target and the autonomous mobile robot 11, in a case where the autonomous mobile robot 11 is too close to the follow-up target or the like, a situation in which the distance detection unit 23 cannot appropriately detect the distance of the follow-up target might occur. The movement control unit 25 may forcibly stop the movement of the autonomous mobile robot 11 in a case where the distance detection unit 23 notifies the same that such a situation occurs. The movement control unit 25 resumes the movement of the autonomous mobile robot 11 in a case where the distance detection unit 23 notifies the same that the distance of the follow-up target can be appropriately detected while the autonomous mobile robot 11 stops moving.

### <Entire Processing of Autonomous Mobile Robot 11>

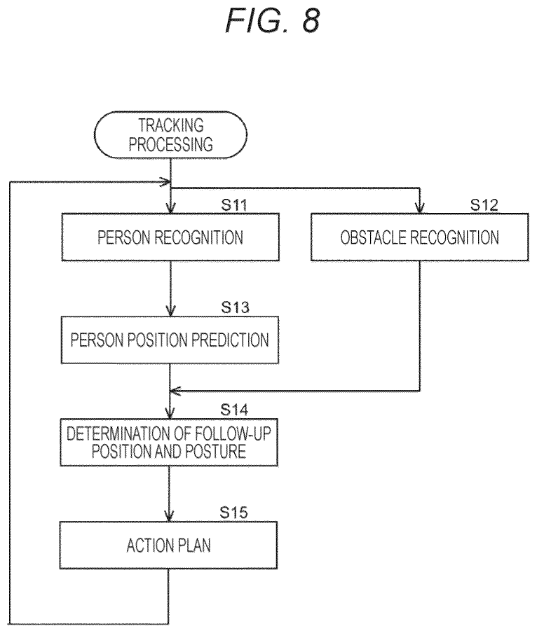

FIG. 8 is a flowchart illustrating an entire flow of follow-up processing executed by the autonomous mobile robot 11 to follow the follow-up target to move. Note that, FIG. 8 illustrates a case where the follow-up target is the person 41 as illustrated in FIGS. 2 to 7.

In FIG. 8, the follow-up target recognition unit 22 recognizes the person 41 as the follow-up target on the basis of the sensor data from the sensor unit 21 at step S11. That is, the follow-up target recognition unit 22 recognizes the position of the person 41 as the follow-up target on the basis of the region of the person 41 in the capturing range 61 and the distance of the person 41 detected by the distance detection unit 23. The processing proceeds from step S11 to step S13.

At step S12, in parallel with the processing at step S11, the movement control unit 25 recognizes the obstacle present around the autonomous mobile robot 11 on the basis of the sensor data from the sensor unit 21. The processing proceeds from step S12 to step S13.

At step S13, the follow-up target prediction unit 24 predicts the trajectory (position) of the person 41 in the future on the basis of the position of the person 41 recognized at step S11. The processing proceeds from step S13 to step S14.

At step S14, the movement control unit 25 determines the follow-up position and posture after a lapse of a predetermined time of the autonomous mobile robot 11 on the basis of the position of the person 41 predicted at step S13 and the presence (position) of the obstacle recognized at step S12. The processing proceeds from step S14 to step S15.

At step S15, the movement control unit 25 determines the trajectory (action plan) through which the autonomous mobile robot 11 should move in accordance with the follow-up position and posture determined at step S14, and drives the autonomous mobile robot 11 according to the determined trajectory. The processing returns from step S15 to steps S11 and S12, and the processing at steps S11 to S15 is repeatedly executed.

### <Processing of Determining Follow-up Position and Posture>

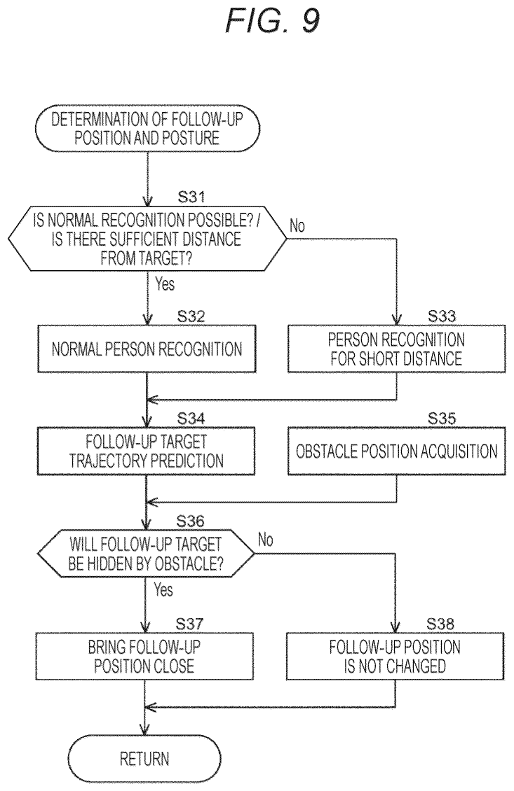

FIG. 9 is a flowchart illustrating processing related to the determination of the follow-up position and posture of the autonomous mobile robot 11 at step S14 in FIG. 8.

At step S31, the follow-up target recognition unit 22 determines whether or not the person 41 as the follow-up target can be recognized by the normal recognition algorithm, that is, whether or not the distance of the person 41 detected by the distance detection unit 23 is the normal distance that can be recognized by the normal recognition algorithm.

In a case where it is determined at step S31 that the person 41 as the follow-up target can be recognized by the normal recognition algorithm, that is, in a case where it is determined that the distance of the person 41 as the follow-up target is the normal distance, the processing proceeds to step S32.

At step S32, the follow-up target recognition unit 22 recognizes the person 41 as the follow-up target by the normal recognition algorithm. Note that, since the follow-up target to be recognized is the person 41, the recognition of the person by the normal recognition algorithm is described as normal person recognition at step S32 in FIG. 9. The processing proceeds from step S32 to step S34.

In a case where it is determined at step S31 that the person 41 as the follow-up target cannot be recognized by the normal recognition algorithm, that is, in a case where it is determined that the distance of the person 41 as the follow-up target is a distance shorter than the normal distance, the processing proceeds to step S33.

At step S33, the follow-up target recognition unit 22 recognizes the person 41 as the follow-up target by the recognition algorithm for short distance. Note that, since the follow-up target to be recognized is the person 41, the recognition of the person by the recognition algorithm for short distance is described as person recognition for short distance at step S33 in FIG. 9. The processing proceeds from step S33 to step S34.

At step S34, the follow-up target prediction unit 24 predicts the future trajectory of the person 41 as the follow-up target on the basis of the position of the person 41 as the follow-up target recognized at step S32 or S33. The processing proceeds from step S34 to step S36.

Note that, step S35 is processing in which the movement control unit 25 acquires the position of the obstacle by obstacle recognition at step S12 in FIG. 8.

At step S36, the movement control unit 25 determines whether or not the person 41 as the follow-up target might be hidden by the obstacle as seen from the sensor unit 21 of the autonomous mobile robot 11 on the basis of the trajectory of the person 41 as the follow-up target predicted at step S34 and the position of the obstacle acquired at step S35.

In a case where it is determined at step S36 that the person 41 as the follow-up target might be hidden by the obstacle, the processing proceeds to step S37, and the movement control unit 25 determines the follow-up position of the autonomous mobile robot 11 to be a position (position at a short distance) closer to the person 41 as the follow-up target at a shorter distance than the normal distance in a case of the principle.

In a case where it is determined at step S36 that the person 41 as the follow-up target might not be hidden by the obstacle, the processing proceeds to step S38, and the movement control unit 25 determines the follow-up position of the autonomous mobile robot 11 to be a position at the normal distance from the person 41 as the follow-up target according to the principle.

When the processing at step S37 or S38 is executed, the processing in this flowchart ends.

As described above, according to the present technology, the recognition algorithm for recognizing the follow-up target is switched depending on the distance between the autonomous mobile robot 11 (sensor unit 21) and the follow-up target. Therefore, even in a case where the autonomous mobile robot 11 is brought close to the follow-up target in order to avoid a situation in which the follow-up target cannot be recognized (captured) due to the obstacle and the like, the follow-up target can be appropriately captured and the autonomous mobile robot 11 can be allowed to follow the follow-up target.

Hereinafter, specific examples of use of the autonomous mobile robot 11 will be described.

### Specific Example 1

As Specific Example 1 in a case where the autonomous mobile robot 11 is utilized, there is a case where the autonomous mobile robot 11 carries a load while following a person in a factory.

A utilization environment of the autonomous mobile robot 11 in Specific Example 1 is as follows.
As a dynamic obstacle, there are a person, a carriage, an automatic door and the like.
As a static obstacle, there is a corner of a passage. Since a width of the passage is secured to some extent, there are few obstacles on the passage itself.
A user of the autonomous mobile robot 11 and people around the same are accustomed to the robot.
A person might temporarily stop due to other work.
The person as the follow-up target often moves at a low speed to some extent.
As a situation in which the autonomous mobile robot 11 fails to follow, there mainly is a case where the person as the follow-up target turns at a corner.

In the utilization environment in Specific Example 1, processing and control regarding the autonomous mobile robot 11 may be optimized in the following form.

The movement control unit 25 that determines the follow-up position and posture of the autonomous mobile robot 11, determines the trajectory thereof, drives the same and the like controls the autonomous mobile robot 11 as follows.

When determining that the person as the follow-up target is shielded from the autonomous mobile robot 11 at the corner, the movement control unit 25 allows the autonomous mobile robot 11 to move so as to approach the person as the follow-up target to such an extent without danger in consideration of the load. Note that, the movement control unit 25 prevents the autonomous mobile robot 11 from approaching the follow-up target to a distance shorter than a braking distance when the autonomous mobile robot 11 is braked in a case where the person as the follow-up target suddenly stops. In a case where the distance at which the autonomous mobile robot 11 and the person as the follow-up target can be closest to each other is limited on the basis of the braking distance, the movement control unit 25 considers the maximum brake amount of the autonomous mobile robot 11 and considers that the maximum brake amount is limited depending on a weight and fragility of the load. Since the braking distance can be shortened by reducing the moving speed, the movement control unit 25 reduces the moving speed of the autonomous mobile robot 11 as the autonomous mobile robot 11 approaches the person as the follow-up target when bringing the autonomous mobile robot 11 close to the person as the follow-up target.

Since workers often wear the same clothes in a factory, the follow-up target recognition unit 22 that recognizes the follow-up target adopts the eighth recognition algorithm using the ranging sensor as the recognition algorithm for short distance.

In a case where the follow-up target prediction unit 24 that predicts the trajectory of the follow-up target has a map (a map for using a robot) indicating a passable passage in the factory, this predicts the trajectory of the person as the follow-up target using the map. In a case where the follow-up target prediction unit 24 has prior knowledge about a conveyance place, this predicts the trajectory of the person as the follow-up target on the basis of the information.

### Specific Example 2

As Specific Example 2 in a case where the autonomous mobile robot 11 is utilized, there is a case where the autonomous mobile robot 11 creates a map for robot while following a person in a factory.

A utilization environment of the autonomous mobile robot 11 in Specific Example 2 is similar to that in Specific Example 1, so that this is omitted.

In the utilization environment in Specific Example 2, processing and control regarding the autonomous mobile robot 11 may be optimized in the following form.

The movement control unit 25 that determines the follow-up position and posture of the autonomous mobile robot 11, determines the trajectory thereof, drives the same and the like controls the autonomous mobile robot 11 as follows.

When determining that the person as the follow-up target is shielded from the autonomous mobile robot 11 at the corner, the movement control unit 25 allows the autonomous mobile robot 11 to move so as to approach the person as the follow-up target to such an extent without danger. Note that, the movement control unit 25 prevents the autonomous mobile robot 11 from approaching the follow-up target to a distance shorter than a braking distance when the autonomous mobile robot 11 is braked in a case where the person as the follow-up target suddenly stops. In a case where the distance at which the autonomous mobile robot 11 and the person as the follow-up target can be closest to each other is limited on the basis of the braking distance, the movement control unit 25 considers the maximum brake amount of the autonomous mobile robot 11. Since the braking distance can be shortened by reducing the moving speed, the movement control unit 25 reduces the moving speed of the autonomous mobile robot 11 as the autonomous mobile robot 11 approaches the person as the follow-up target when bringing the autonomous mobile robot 11 close to the person as the follow-up target.

Specific Example 2 is a case where the autonomous mobile robot 11 is utilized to create the map for robot in the factory, so that the follow-up target prediction unit 24 that predicts the trajectory of the follow-up target does not have the map for robot. The follow-up target prediction unit 24 predicts the trajectory of the person as the follow-up target by a method using a particle filter or a method using a moving model, for example.

### Specific Example 3

As Specific Example 3 in a case where the autonomous mobile robot 11 is utilized, there is a case where the autonomous mobile robot 11 carries a load while following a person in a factory.

A utilization environment of the autonomous mobile robot 11 in Specific Example 3 is as follows.
As a dynamic obstacle, there are a person, a carriage, an automatic door and the like.
As a static obstacle, there is a corner of a passage. There are many corners. A width of the passage is narrow, and there is an obstacle on the passage.
A user of the autonomous mobile robot 11 and people around the same are accustomed to the robot.

A person might temporarily stop due to other work.
As a situation in which the autonomous mobile robot 11 fails to follow, there is a case where the person as the follow-up target turns at a corner.
As a situation in which the autonomous mobile robot 11 fails to follow, there is a case that the autonomous mobile robot 11 fails to capture the person as the follow-up target while performing avoidance operation to avoid the person and the like.

In the utilization environment in Specific Example 3, processing and control regarding the autonomous mobile robot 11 may be optimized in the following form.

The movement control unit 25 that determines the follow-up position and posture of the autonomous mobile robot 11, determines the trajectory thereof, drives the same and the like controls the autonomous mobile robot 11 as follows.

When determining that the person as the follow-up target is shielded from the autonomous mobile robot 11 when reaching the corner and the like, the movement control unit 25 allows the autonomous mobile robot 11 to move so as to approach the person as the follow-up target. Note that, the movement control unit 25 prevents the autonomous mobile robot 11 from approaching the follow-up target to a distance shorter than a braking distance when the autonomous mobile robot 11 is braked in a case where the person as the follow-up target suddenly stops. Moreover, the movement control unit 25 does not allow the autonomous mobile robot 11 to approach the person to a distance in consideration of a personal space that the person feels uncomfortable or shorter. The movement control unit 25 predicts a trajectory of a pedestrian walking in the vicinity other than the follow-up target. In a case where the movement control unit 25 determines that the pedestrian tries to cut in between the person as the follow-up target and the autonomous mobile robot 11 on the basis of the predicted trajectory of the pedestrian, this brings the autonomous mobile robot 11 close to the person as the follow-up target to such an extent that the pedestrian cannot cut in. As a result, it is possible to prevent the capture of the person as the follow-up target from being obstructed by other pedestrians.

In a case where a plurality of persons exists in a narrow road width in the recognition algorithm for short distance, the follow-up target recognition unit 22 that recognizes the follow-up target often erroneously recognizes another person as the follow-up target in the recognition algorithm that recognizes the mobile object as the person as the follow-up target, so that this adopts the sixth recognition algorithm using feature amount extraction as the recognition algorithm for short distance.

The follow-up target prediction unit 24 that predicts the trajectory of the follow-up target deduces a passable passage by using a map in an office, and predicts the trajectory of the person as the follow-up target by using a method using a particle filter or the like.

### Specific Example 4

As Specific Example 4 in a case where the autonomous mobile robot 11 is utilized, there is a case where the autonomous mobile robot 11 carries a load while following a person in an airport.

A utilization environment of the autonomous mobile robot 11 in Specific Example 4 is as follows.
Examples of a dynamic obstacle include a person, a carry case and a cart carried by a person and the like.
As a static obstacle, there is a pillar and the like. This is often an open space and there are few static obstacles.
A user of the autonomous mobile robot 11 and people around the same do not move while being conscious of the autonomous mobile robot 11.
The person as the follow-up target often moves at a normal walking speed.
As a situation in which the autonomous mobile robot 11 fails to follow, there is a case where the person as the follow-up target turns at a corner.
As a situation in which the autonomous mobile robot 11 fails to follow, there is a case that the autonomous mobile robot 11 fails to capture the person as the follow-up target while performing avoidance operation to avoid the person and the like.
As a situation in which the autonomous mobile robot 11 fails to follow, there is a case where the dynamic obstacle cuts in between the autonomous mobile robot 11 and the person as the follow-up target.
As a situation in which the autonomous mobile robot 11 fails to follow, there is a case where the autonomous mobile robot 11 does not move to all directions but is of a two-wheel differential type and the like, for example, a case where the person as the follow-up target greatly changes the moving direction to a lateral direction and the like and deviates from the capturing range 61.

In the utilization environment in Specific Example 4, processing and control regarding the autonomous mobile robot 11 may be optimized in the following form.

The movement control unit 25 that determines the follow-up position and posture of the autonomous mobile robot 11, determines the trajectory thereof, drives the same and the like controls the autonomous mobile robot 11 as follows.

The movement control unit 25 predicts a trajectory of a pedestrian walking in the vicinity other than the follow-up target as in the case of Specific Example 3. In a case where the movement control unit 25 determines that the pedestrian tries to cut in between the person as the follow-up target and the autonomous mobile robot 11 on the basis of the predicted trajectory of the pedestrian, this brings the autonomous mobile robot 11 close to the person as the follow-up target to such an extent that the pedestrian cannot cut in. Even in a case where the autonomous mobile robot 11 is brought close to the person as the follow-up target so that the pedestrian cannot cut in, in a case where the moving direction of the pedestrian does not change, there is a possibility of collision, so that the movement control unit 25 stops bringing the autonomous mobile robot 11 close to the person as the follow-up target and gives priority to collision avoidance with the pedestrian. The movement control unit 25 directs the autonomous mobile robot 11 in a direction in which presence likelihood of the person as the follow-up target is high, and attempts to recognize the person as the follow-up target by the follow-up target recognition unit 22. In a case where the person cannot be recognized, the movement control unit 25 (or the follow-up target prediction unit 24) estimates the trajectory of the person as the follow-up target.

When the follow-up target recognition unit 22 that recognizes the follow-up target uses a method based on a distance when recognizing the person when the person as the follow-up target approaches the autonomous mobile robot 11, erroneous recognition with the people around occurs, so that this adopts the sixth recognition algorithm using feature amount extraction as the recognition algorithm for short distance.

### <Program>

The above-described series of processing in the autonomous mobile robot 11 can be executed by hardware or can be executed by software. In a case where a series of processing is executed by the software, a program forming the software is installed on a computer. Here, the computer includes a computer incorporated in dedicated hardware, a general-purpose personal computer capable of executing various functions by installing various programs and the like, for example.

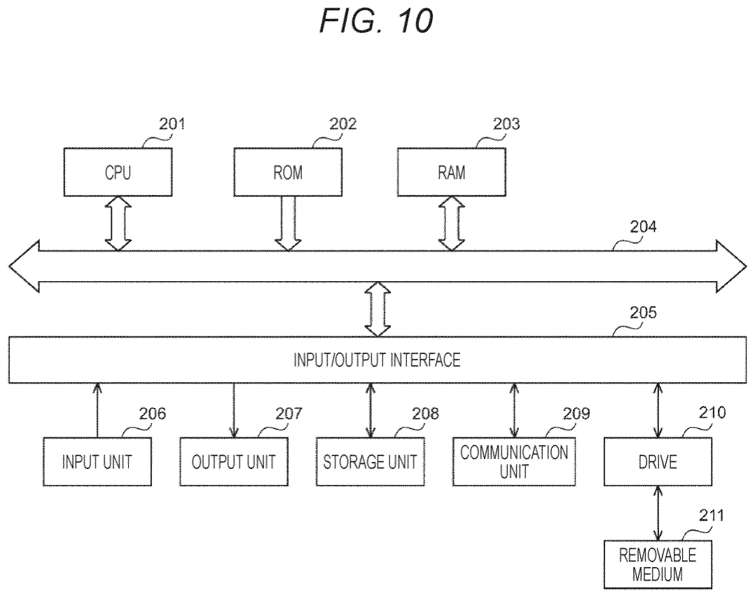

FIG. 10 is a block diagram illustrating a configuration example of the hardware of the computer in a case where the computer executes each processing executed by the autonomous mobile robot 11 with a program.

In the computer, a central processing unit (CPU) 201, a read only memory (ROM) 202, and a random access memory (RAN) 203 are connected to each other by a bus 204.

An input/output interface 205 is further connected to the bus 204. The input/output interface 205 is connected to an input unit 206, an output unit 207, a storage unit 208, a communication unit 209, and a drive 210.

The input unit 206 includes a keyboard, a mouse, a microphone and the like. The output unit 207 includes a display, a speaker and the like. The storage unit 208 includes a hard disk, a non-volatile memory and the like. The communication unit 209 includes a network interface and the like. The drive 210 drives a removable medium 211 such as a magnetic disk, an optical disk, a magnetooptical disk, or a semiconductor memory.

In the computer configured as described above, for example, the CPU 201 loads the program stored in the storage unit 208 into the RAM 203 via the input/output interface 205 and the bus 204 and executes the program, thereby performing the above-described series of processing.

The program executed by the computer (CPU 201) can be provided by being recorded on the removable medium 211 as a package medium or the like, for example. Furthermore, the program can be provided via a wired or wireless transmission medium such as a local area network, the Internet, or digital broadcasting.

In the computer, the program can be installed in the storage unit 208 via the input/output interface 205 by loading the removable medium 211 in the drive 210. Furthermore, the program can be received by the communication unit 209 via a wired or wireless transmission medium and installed on the storage unit 208. Additionally, the program may be installed in advance on the ROM 202 and the storage unit 208.

Note that, the program executed by the computer may be a program for processing in time series in the order described in this specification, or a program for processing in parallel or at a necessary timing such as when a call is made.

The present technology can also have the following configurations.

(1)

An information processing device including:
a drive unit that is driven for following a follow-up target;
a recognition unit that recognizes the follow-up target, the recognition unit that changes a recognition algorithm for recognizing the follow-up target on the basis of a distance to the follow-up target or recognition accuracy of the follow-up target based on the distance to the follow-up target; and
a control unit that controls the drive unit on the basis of a position of the follow-up target recognized by the recognition unit.

(2)

The information processing device according to (1) described above, in which
the recognition unit
sets, in a case where the distance to the follow-up target is a normal distance equal to or longer than a predetermined distance threshold, the recognition algorithm to a recognition algorithm for normal distance, and
sets, in a case where the distance to the follow-up target is shorter than the distance threshold, the recognition algorithm to a recognition algorithm for short distance.

(3)

The information processing device according to (2) described above, in which
the recognition unit
detects a region matching an entire feature of the follow-up target from an image imaged by a camera as the recognition algorithm for normal distance.

(4)

The information processing device according to (2) described above, in which
the recognition unit
detects a region of a mobile body as a region of the follow-up target from an image imaged by a camera as the recognition algorithm for normal distance.

(5)

The information processing device according to (2) described above, in which
the recognition unit
detects a region of a mobile body as a region of the follow-up target from a ranging range ranged by a ranging sensor as the recognition algorithm for normal distance.

(6)

The information processing device according to (2) described above, in which
the recognition unit
detects a region matching a shape of the follow-up target from a ranging range ranged by a ranging sensor as the recognition algorithm for normal distance.

(7)

The information processing device according to any one of (2) to (6) described above, in which
the recognition unit
detects a region matching a representative color of the follow-up target from an image imaged by a camera as the recognition algorithm for short distance.

(8)

The information processing device according to any one of (2) to (6), in which
the recognition unit
detects a region matching a feature amount corresponding to the follow-up target from an image imaged by a camera as the recognition algorithm for short distance.

(9)

The information processing device according to any one of (2) to (6) described above, in which
the recognition unit
detects a region of a mobile body as a region of the follow-up target from a ranging range ranged by a ranging sensor as the recognition algorithm for short distance.

(10)

The information processing device according to any one of (2) to (9) described above, further including:
a prediction unit that predicts a trajectory of the follow-up target, in which
the control unit controls, in a case where it is predicted that recognition of the recognition unit with respect to the follow-up target that moves along the trajectory predicted by the prediction unit is obstructed by an obstacle, the drive unit so that a distance to the follow-up target becomes shorter than the distance threshold.

(11)

The information processing device according to any one of (2) to (10) described above, further including:
a prediction unit that predicts a trajectory of the follow-up target, in which
the control unit controls, in a case where it is predicted that the follow-up target that moves along the trajectory predicted by the prediction unit deviates from a capturing range in which the recognition unit is able to recognize the follow-up target, the drive unit so that a distance to the follow-up target becomes shorter than the distance threshold.

(12)

The information processing device according to any one of (2) to (11) described above, in which
the normal distance is a distance at which the recognition unit is able to recognize an entire follow-up target.

(13)

The information processing device according to any one of (1) to (12) described above, in which the follow-up target is a person.

(14)

An information processing method of an information processing device including a drive unit, a recognition unit, and a control unit, the method including:
a drive step for the drive unit to be driven for following a follow-up target;
a recognition step for the recognition unit to recognize the follow-up target, the recognition step of changing a recognition algorithm for recognizing the follow-up target on the basis of a distance to the follow-up target or recognition accuracy of the follow-up target based on the distance to the follow-up target; and
a control step for the control unit to control the drive at the drive step on the basis of a position of the follow-up target recognized at the recognition step.

(15)

A program that allows a computer to serve as:
a drive unit that is driven for following a follow-up target;
a recognition unit that recognizes the follow-up target, the recognition unit that changes a recognition algorithm for recognizing the follow-up target on the basis of a distance to the follow-up target or recognition accuracy of the follow-up target based on the distance to the follow-up target; and
a control unit that controls the drive unit on the basis of a position of the follow-up target recognized by the recognition unit.

### REFERENCE SIGNS LIST

11 Autonomous mobile robot
21 Sensor unit
22 Follow-up target recognition unit
23 Distance detection unit
24 Follow-up target prediction unit
25 Movement control unit
26 Drive unit

1. An information processing device comprising:
a drive unit that is driven for following a follow-up target;
a recognition unit that recognizes the follow-up target, the recognition unit that changes a recognition algorithm for recognizing the follow-up target on a basis of a distance to the follow-up target or recognition accuracy of the follow-up target based on the distance to the follow-up target; and
a control unit that controls the drive unit on a basis of a position of the follow-up target recognized by the recognition unit.

2. The information processing device according to claim 1, wherein
the recognition unit
sets, in a case where the distance to the follow-up target is a normal distance equal to or longer than a predetermined distance threshold, the recognition algorithm to a recognition algorithm for normal distance, and
sets, in a case where the distance to the follow-up target is shorter than the distance threshold, the recognition algorithm to a recognition algorithm for short distance.

3. The information processing device according to claim 2, wherein
the recognition unit
detects a region matching an entire feature of the follow-up target from an image imaged by a camera as the recognition algorithm for normal distance.

4. The information processing device according to claim 2, wherein
the recognition unit
detects a region of a mobile body as a region of the follow-up target from an image imaged by a camera as the recognition algorithm for normal distance.

5. The information processing device according to claim 2, wherein
the recognition unit
detects a region of a mobile body as a region of the follow-up target from a ranging range ranged by a ranging sensor as the recognition algorithm for normal distance.

6. The information processing device according to claim 2, wherein
the recognition unit
detects a region matching a shape of the follow-up target from a ranging range ranged by a ranging sensor as the recognition algorithm for normal distance.

7. The information processing device according to claim 2, wherein
the recognition unit
detects a region matching a representative color of the follow-up target from an image imaged by a camera as the recognition algorithm for short distance.

8. The information processing device according to claim 2, wherein
the recognition unit
detects a region matching a feature amount corresponding to the follow-up target from an image imaged by a camera as the recognition algorithm for short distance.

9. The information processing device according to claim 2, wherein
the recognition unit
detects a region of a mobile body as a region of the follow-up target from a ranging range ranged by a ranging sensor as the recognition algorithm for short distance.

10. The information processing device according to claim 2, further comprising:
a prediction unit that predicts a trajectory of the follow-up target, wherein
the control unit controls, in a case where it is predicted that recognition of the recognition unit with respect to the follow-up target that moves along the trajectory predicted by the prediction unit is obstructed by an obstacle, the drive unit so that a distance to the follow-up target becomes shorter than the distance threshold.

11. The information processing device according to claim 2, further comprising:
a prediction unit that predicts a trajectory of the follow-up target, wherein
the control unit controls, in a case where it is predicted that the follow-up target that moves along the trajectory predicted by the prediction unit deviates from a capturing range in which the recognition unit is able to recognize the follow-up target, the drive unit so that a distance to the follow-up target becomes shorter than the distance threshold.

12. The information processing device according to claim 2, wherein
the normal distance is a distance at which the recognition unit is able to recognize an entire follow-up target.

13. The information processing device according to claim 1, wherein
the follow-up target is a person.

14. An information processing method of an information processing device including a drive unit, a recognition unit, and a control unit, the method comprising:
a drive step for the drive unit to be driven for following a follow-up target;
a recognition step for the recognition unit to recognize the follow-up target, the recognition step of changing a recognition algorithm for recognizing the follow-up target on a basis of a distance to the follow-up target or recognition accuracy of the follow-up target based on the distance to the follow-up target; and
a control step for the control unit to control the drive at the drive step on a basis of a position of the follow-up target recognized at the recognition step.

15. A program that allows a computer to serve as:
a drive unit that is driven for following a follow-up target;
a recognition unit that recognizes the follow-up target, the recognition unit that changes a recognition algorithm for recognizing the follow-up target on a basis of a distance to the follow-up target or recognition accuracy of the follow-up target based on the distance to the follow-up target; and
a control unit that controls the drive unit on a basis of a position of the follow-up target recognized by the recognition unit.
